(19) United States
(12) Patent Application Publication
(10) Pub. No.: US 2012/0076322 A1
(43) Pub. Date: Mar. 29, 2012

(54) MICROPHONE

(75) Inventors: Norio Kimura, Kanagawa (JP); Shigeo Masai, Osaka (JP); Yasuhiro Nakanosai, Fukushima (JP)

(73) Assignees: NGB Corporation, Tokyo (JP); Panasonic Corporation, Osaka (JP)

(21) Appl. No.: 13/311,260

(22) Filed: Dec. 5, 2011

Related U.S. Application Data
(63) Continuation of application No. PCT/JP2010/003378, filed on May 19, 2010.

(30) Foreign Application Priority Data
Jun. 4, 2009 (JP) 2009-135247

(51) Int. Cl. H04B 15/00

(52) U.S. Cl. 381/94.9

(57) ABSTRACT

There is provided a microphone that can suppress vibration noise stemming from mechanical vibrations and that outputs a collective signal having superior quality.

There is provided a microphone comprising a first capacitance section M1 having a first movable electrode 101 and a second electrode 102 disposed opposite the first electrode 101 and a second capacitance section M2 that has a first movable electrode 111 and a second electrode 112 disposed opposite the first electrode 111; a first amplifier 201 that amplifies a signal from the first electrode 101 of the first capacitance section M1 and a signal from the second electrode 112 of the second capacitance section M2; and a second amplifier 202 that amplifies a signal from the second electrode 102 of the first capacitance section M1 and a signal from the first electrode 111 of the second capacitance section M2.

### BACKGROUND OF THE INVENTION

1. Technical Field

The present invention relates to a capacitor microphone and, more particularly, to suppressing vibration noise stemming from mechanical vibrations. Further, the present invention relates to a capacitance microphone that effectively utilizes electric charges developing in two mutually opposite electrodes making up a capacitance section.

2. Description Related Art

A capacitance section making up a capacitance microphone is a sensor that outputs an electric signal in accordance with vibration and wobbling of mutually opposite electrodes placed in the capacitance section by way of electrostatic energy. In addition to the capacitance microphone, a pressure sensor, an acceleration sensor, and the like, are available as sensors that each have capacitance sections. The capacitance microphone and the pressure sensor are sensors for sensing vibrations of the mutually opposite electrodes, while the acceleration sensor is a sensor for sensing wobbles.

In the capacitance microphone, a signal output from a sensor during collection of a conversation is a very faint signal whose power is of the order of 3 mV to 10 mV. In the meantime, since a vibrating film has a finite mass, extraneous force is applied to the vibrating film by means of extraneous mechanical vibrations, whereupon the vibrating film vibrates. When such a vibrating noise signal stemming from the extraneous mechanical vibrations is mingled with a collective audio signal, signal quality of the collective audio signal becomes worse, because the collective audio signal is faint.

### [Mathematical Expression 1]

Provided that acceleration of extraneous mechanical vibrations is

$$a [ \frac{m}{{sec}^{2}} ]$$

and a mass of the vibrating film is mₒ[kg], external force F_{VIB}[N] exerted to the vibrating film is given by

F_{VIB}[N]=mₒ·a=S_{dia}δ_{DIA}·a,

where

S_{DIA} [m²]: an area of the vibrating film

$${σ}_{DIA} [ \frac{kg}{{m}^{2}} ] \text{:}$$

a density of the vibrating film

Meanwhile, when a reference is made to the related art, Patent Document 1 describes a technique for preventing transfer of extraneous vibrations to a microphone by mounting the microphone onto a substrate by way of elastic rubber.

Patent Document 2 describes a technique for placing two capacitance microphone elements in a package, thereby suppressing impact sound which will arise when an impact is exerted on a microphone.
Patent Document 1: JP-A-9-215081
Patent Document 2: JP-A-2008-227652

### SUMMARY OF THE INVENTION

In the field of portable communication terminals, movie cameras, digital cameras, and the like, an increasing demand exists for suppressing vibration noise. The devices are increasingly miniaturized, and there also exists a growing demand for miniaturizing components used in the devices. To meet the demands, the present invention aims at providing a capacitance microphone that lessens influence of vibration noise on a collective audio signal exerted by extraneous mechanical vibrations and that can also be miniaturized.

A microphone of the present invention has a first capacitance section and a second capacitance section that each have a first electrode which is a movable electrode and a second electrode which is disposed opposite the first electrode; a first amplifier that amplifies a signal from the first electrode of the first capacitance section and a signal from the second electrode of the second capacitance section; and a second amplifier that amplifies a signal from the second electrode of the first capacitance section and a signal from the first electrode of the second capacitance section.

In the first capacitance section of the microphone of the present invention, the first electrode that is a movable electrode is connected to the first amplifier, and the second electrode opposing the first electrode is connected to the second amplifier. As a consequence, in response to movements of the movable electrodes (vibration electrodes) caused by an acoustic wave or vibrations, complementary signals appear on the respective electrodes, whereby electric charges and signals, like voltages, on the respective electrodes become opposite in phase to each other. Likewise, amplified signals also become opposite in phase to each other, so that the electric charges developed in both electrodes can be effectively utilized (see JP-A-2008-328492).

In the second capacitance section of the microphone of the present invention, the first electrode that is a movable electrode is connected to the second amplifier, and the second electrode opposing the first electrode is connected to the first amplifier. As a result, in response to movements of the movable electrodes (the vibration electrodes) caused by an acoustic wave or vibrations, complementary signals appear on the respective electrodes, whereby electric charges and signals, like voltages, on the respective electrodes become opposite in phase to each other. Likewise, amplified signals also become opposite in phase to each other, so that the electric charges developed in both electrodes can be effectively utilized.

When the connection is viewed from the amplifiers, the mutually-opposite electrodes making up the first capacitance section and the second capacitance section are connected in opposite polarities. Therefore, it is possible to double an output by making a balanced connection of signals or subtracting one signal from another signal by adoption of an amplifier having a subtraction capability to be described later. Moreover, when external noise mixedly enters the capacitance sections, the signals will become in phase with each other, so that the external noise can be lessened.

The microphone of the present invention preferably further includes a substrate on which there are arranged the first capacitance section, the second capacitance section, the first amplifier, and the second amplifier; a cover arranged on the substrate so as to cover the first capacitance section, the second capacitance section, the first amplifier, and the second amplifier; and an opening formed in a position on the substrate below the first capacitance section, wherein a position on the substrate below the second capacitance section is closed.

As a result of adoption of the above configuration, when pressure, such as acoustic pressure, is introduced by way of the opening, space [space partitioned (defined) by the first capacitance section, the cover, and the substrate] located on the other side of the opening with the movable electrode, which makes up the first capacitance section, sandwiched therebetween turns into acoustic space. When compared with a case where only space located immediately above the first capacitance section turns into acoustic space, the volume of the acoustic space becomes greater; hence, stiffness (rigidity) of the space can be lessened. Further, the stiffness of the space can be made smaller than stiffness of the movable electrode of the first capacitance section and the movable electrode of the second capacitance section. Acoustic energy introduced by way of the opening travels to the movable electrode of the second capacitance section after having vibrated the movable electrode of the first capacitance section. When the volume of the acoustic space becomes greater, the acoustic energy becomes likely to dissipate or spread within the acoustic space, so that the acoustic energy applied to the movable electrode of the second capacitance section becomes very smaller.

Therefore, vibrations of the movable electrode of the second capacitance section caused by the acoustic energy become considerably smaller than vibrations of the movable electrode of the first capacitance section. This means that mutual interference of acoustic sensitivity is extremely small and that acoustic sensitivity of the microphone caused by the acoustic energy is determined by the acoustic sensitivity of the first capacitance section.

Consideration is now given to the vibration energy caused by vibration of the entire microphone. Since the first capacitance section and the second capacitance section are placed on a single substrate, acceleration of the same magnitude is exerted on the respective movable electrodes of the first capacitance section and the second capacitance section. Specifically, vibration energy of the same phase is exerted on the respective movable electrodes. Consequently, the first capacitance section and the second capacitance section are connected in parallel to each other and in opposite polarities and combined with a capacitive coupling electric charge amplifier, which will be described later, whereby a noise signal caused by vibration energy can be canceled.

As mentioned above, in relation to acoustic energy, the acoustic sensitivity of the microphone is determined by acoustic sensitivity of the first capacitance section. Vibration energy is canceled. Therefore, sensitivity of the first capacitance section to pressure, such as acoustic pressure, can be enhanced, and the function of the microphone is enhanced.

In the microphone of the present invention, a terminal for exchanging a signal with an outside is preferably provided on another side of the substrate mounted with the cover.

In the microphone of the present invention, a voltage supply terminal and a ground terminal are preferably provided on another side of the substrate provided with the cover. The voltage supply terminal has a function of imparting a voltage to the first amplifier and the second amplifier. By means of the configuration, it is possible to provide a compact microphone exhibiting a superior surface mount property.

Preferably, the microphone of the present invention has a container for housing the first capacitance section, the second capacitance section, the first amplifier, and the second amplifier. It is preferable that an output terminal of the first amplifier, an output terminal of the second amplifier, a voltage supply terminal that supplies a voltage to the first amplifier and the second amplifier, and a ground terminal will be led out of the container.

Moreover, in the microphone of the present invention, it is preferable that first rigidity of space defined by the substrate, the first capacitance section, and the cover is smaller than second rigidity of the first electrode of the first capacitance section.

Further, in the microphone of the present invention, it is preferable that the first rigidity is one-tenth or less of the second rigidity. By adoption of such a relationship, the acoustic energy exerted on the movable electrode of the second capacitance section can be made sufficiently smaller.

In the microphone of the present invention, it is also preferable that a volume of space defined by the substrate, such as a printed board, the first capacitance section, and the cover is ten times or more a volume of space closed by the second capacitance section and the substrate. The first capacitance section and the second capacitance section have a semiconductor substrate that is typified by a silicon substrate and that supports a structure made up of the first electrode and the second electrode. A through hole is formed in the semiconductor substrate. Space occupied by the through hole is a representative of the space closed by the second capacitance section and the substrate.

It is preferable that the microphone of the present invention should have a third amplifier having a capability of performing subtraction of an output signal from the first amplifier and an output signal from the second amplifier.

It is preferable for the microphone of the present invention that the first amplifier and the second amplifier are formed into an IC. The configuration makes it possible to further miniaturize the microphone.

It is preferable for the microphone of the present invention that the first amplifier and the second amplifier are formed into a single IC. The configuration makes it possible to further miniaturize the microphone.

It is preferable for the microphone of the present invention that the first amplifier, the second amplifier, and the third amplifier should be formed in a single IC.

It is preferable for the microphone of the present invention that the first amplifier and the second amplifier should make up a capacitive coupling electric charge amplifier. The capacitive coupling electric charge amplifier is an amplifier capable of determining a degree of amplification by means of capacitance of a capacitive sensor element section (a capacitance section) and a feedback capacitor connected to the input terminal and the output terminal of the amplifier. Thus, the capacitive coupling electric charge amplifier can be implemented by means of a simple configuration. Moreover, the capacitive coupling electric charge amplifier is an inverting amplifier, and an input terminal of the amplifier is virtually short-circuited. Therefore, even when parasitic capacitance exists in the input terminal and the capacitance section, the amplifier operates as one that is not affected by the parasitic capacitance.

Since the second amplifier is virtually short-circuited from the viewpoint of the first amplifier, an electrode opposing the electrode connected to the first amplifier of the capacitance section becomes virtually short-circuited, so that the second amplifier is not affected.

The same can also be said from the viewpoint of the second amplifier. Hence, the second amplifier operates without being affected by the mutual amplifiers.

In light of the foregoing property of the inverting capacitive coupling electric charge amplifier, the second capacitance section, in addition to the first capacitance section, is also subjected to a parallel connection. Specifically, a signal of the second electrode of the second capacitance section is connected to an input terminal of the first inverting amplifying capacitive coupling amplifier or the first electrode of the first capacitance section. Moreover, a signal of the first electrode of the second capacitance section is connected to an input terminal of the second inverting capacitive coupling electric charge amplifier or the second electrode of the first capacitance section.

As a result of adoption of the connection, the first capacitance section does not become a load for the second capacitance section. Likewise, the second capacitance section does not become a load for the first capacitance section. Accordingly, signals of the respective capacitance sections can be amplified without involvement of a loss.

Further, in the microphone of the present invention, the input terminal of the first amplifier connects the signal from the first electrode which is the movable electrode of the first capacitance section to a signal of the second electrode which is the opposite electrode of the second capacitance section, as mentioned above. Since a reverse polarity connection is made, the electric charge amplifier is configured so as to be able to perform subtraction.

Likewise, in the microphone of the present invention, the input terminal of the second amplifier connects the signal from the first electrode which is the movable electrode of the second capacitance section to a signal of the second electrode which is the opposite electrode of the first capacitance section, as mentioned above. Since a reverse polarity connection is made, the electric charge amplifier is configured so as to be able to perform subtraction.

As mentioned above, in the microphone of the present invention, the first capacitance section exhibits sensitivity against sound and sensitivity against vibrations. However, the second capacitance section exhibits sensitivity solely against vibrations. Therefore, by virtue of the reverse polarity connection and the characteristic of the capacitive coupling electric charge amplifier, a vibration noise signal that has sufficiently been reduced (suppressed) as a result of the vibration noise signal of the second capacitance section being subtracted from the vibration noise signal of the first capacitance section and a collective audio signal of the first capacitance section are obtained as outputs.

In the microphone of the present invention, it is preferable that the output signal from the first amplifier and the output signal from the second amplifier should be substantially opposite in phase to each other.

In the microphone of the present invention, it is preferable that the first electrode is not connected to a reference potential (a ground potential).

In the microphone of the present invention, it is preferable that the second electrode is not connected to a reference potential (a ground potential).

In the microphone of the present invention, the output signal from the first amplifier and the output signal from the second amplifier are connected to an analogue-digital converter that performs analogue-to-digital conversion, and an output signal can also be a digital signal. Further, such a microphone can also be called a digital signal output microphone. The digital signal output microphone is herein assumed to designate a microphone that outputs a signal (sound, vibrations, wobbles, and the like) input to the microphone as a digital signal including 1s and 0s.

In the microphone of the present invention, the first amplifier, the second amplifier, and the analogue-to-digital converter are preferably formed from an IC. Moreover, it is preferable that the first amplifier, the second amplifier, and the analogue-to-digital converter are formed in a single IC.

In the microphone of the present invention, the analogue-to-digital converter is preferably a Δ sigma modulator.

In the microphone of the present invention, the digital signal is preferably output in compliance with a pulse density modulation (PDM) scheme.

In the microphone of the present invention, it is preferable that a digital signal processor (DSP) converts the digital signal output in compliance with the pulse density modulation (PDM) scheme into an audio interface format and outputs a conversion result.

In the microphone of the present invention, it is preferable that the first capacitance section and the second capacitance section are MEMS element sections. Adopting such a configuration enables obviation of a necessity for external components; miniaturization of the microphone; and exhibition of a highly reliable output characteristic without involvement of occurrence of a connection loss.

In the microphone of the present invention, it is preferable that a dielectric film is formed over a surface of the first electrode or the second electrode.

In the microphone of the present invention, the dielectric film is preferably an electret film holding permanent electric charges. The configuration enables actuation of the microphone without a supply of electric charges (a polarization voltage) from the outside. Further, the configuration obviates a necessity for a connection line for imparting a polarization DC voltage to the MEMS element section making up the capacitance section.

Accordingly, since the connection line does not exert an influence on electric charges or a voltage developing in the first and second electrodes disposed opposite to each other, perfect complementary signals can be produced.

A related art capacitance section making up an electret capacitance element utilizes only a signal of one polarity, because either of the first electrode and the second electrode that are mutually opposite to each other is connected to the reference potential (a ground potential); therefore, a signal utilization factor (efficiency) is 50%. Accordingly, so long as signal electric charges of the first electrode and the second electrode are utilized, the signal utilization factor (efficiency) comes to 100%.

This means that, when the sensitivity of the related art capacitance microphone is taken as one, the sensitivity of the capacitance microphone using the connection configuration of the present invention is doubled.

There is adopted a floating structure in which neither the first electrode nor the second electrode, which are disposed opposite each other as electret capacitance elements, is connected to the reference potential (a ground potential). An MEMS element section that is a micro-electro-mechanical system fabricated on a semiconductor substrate is suitable for means that makes it possible to easily implement the floating structure.

A dielectric film is fixed to either the first electrode or the second electrode, and an electret is used for the dielectric film. As a result, an electret MEMS microphone chip (an electret MEMS capacitance section) can be formed.

Another microphone of the present invention includes a first capacitance section and a second capacitance section that each have a first electrode which is a movable electrode and a second electrode which is disposed opposite the first electrode; a substrate on which there are arranged the first capacitance section and the second capacitance section; a cover arranged on the substrate so as to cover the first capacitance section and the second capacitance section; and an opening formed in a position on the substrate below the first capacitance section, wherein a position on the substrate below the second capacitance section is preferably closed; and a volume of space defined by the substrate, the first capacitance section, and the cover preferably is ten times or more a volume of space closed by the second capacitance section and the substrate. Each of the first capacitance section and the second capacitance section has a semiconductor substrate typified by a silicon substrate that supports a structure made up of a first electrode and a second electrode. The semiconductor substrate has a through hole. Space occupied by the through hole typically represents space closed by the second capacitance section and the substrate.

A capacitance microphone is made up of a container that is formed by mounting the first capacitance section, the second capacitance section, the first amplifier, and the second amplifier on a first surface of a single printed board and covering the thus-mounted elements with a metal cap. The capacitance microphone can be attached to a substrate of another electronic device (like a portable phone). A surface mount terminal is provided on the printed board, which makes it possible to bond the printed board to a substrate of another electronic device. Accordingly, the microphone of the present invention can be conceived as a package that can be mounted on another electronic device.

Needless to say, the foregoing characteristics can be combined with each other, as required, so as not to cause contradiction. Even when the respective characteristics can be expected to yield a plurality of advantages, there is no requirement that all of the advantages must be exhibited.

The present invention makes it possible to provide a microphone capable of producing an output signal whose vibration noise has been sufficiently suppressed. In particular, the present invention can provide a microphone capable of being surface mounted.

### BRIEF DESCRIPTION OF THE DRAWINGS

FIG. 1 is a schematic diagram of an equivalent circuit of a capacitance microphone of a first embodiment of the present invention.

FIG. 2 is a cross sectional view and a diagrammatic illustration of a circuit diagram of an MEMS element section of the first embodiment of the present invention, wherein (a) shows a cross sectional view of the MEMS element section of the first embodiment of the present invention, and wherein (b) shows a diagrammatic illustration of a circuit diagram of the MEMS element section of the first embodiment of the present invention.

FIGS. 3 (a) to (d) include mounting overviews of the capacitance microphone of the first embodiment of the present invention, wherein (a) shows a top view of the capacitance microphone (a module) whose metal cap is removed, wherein (b) shows a left-side view of the capacitance microphone (the module), wherein (c) shows a bottom view of the same, and wherein (d) is a cross sectional view taken along line A-A′ shown in (a).

FIGS. 4 (a) and (b) include descriptive views of circuits of an acoustic mechanism equivalent to the capacitance microphone of the first embodiment of the present invention, wherein (a) and (b) are circuits of the equivalent acoustic mechanism.

FIGS. 5 (a) and (b) include descriptive views of circuits of a vibratory mechanism equivalent to the capacitance microphone of the first embodiment of the present invention, wherein (a) and (b) are circuits of the equivalent vibratory mechanism.

FIG. 6 is a schematic diagram of an equivalent circuit diagram of a prototype capacitance microphone of the first embodiment of the present invention.

FIG. 7 is a descriptive view of the prototype of the first embodiment of the present invention and its real characteristic data.

FIG. 8 is a descriptive view of the prototype of the first embodiment of the present invention and its real characteristic data.

FIG. 9 is a descriptive view of the prototype of the first embodiment of the present invention and its real characteristic data.

FIG. 10 is a schematic diagram of an equivalent circuit diagram of a capacitance microphone of a second embodiment of the present invention.

### DETAILED DESCRIPTION OF THE PREFERRED EMBODIMENTS

### First Embodiment

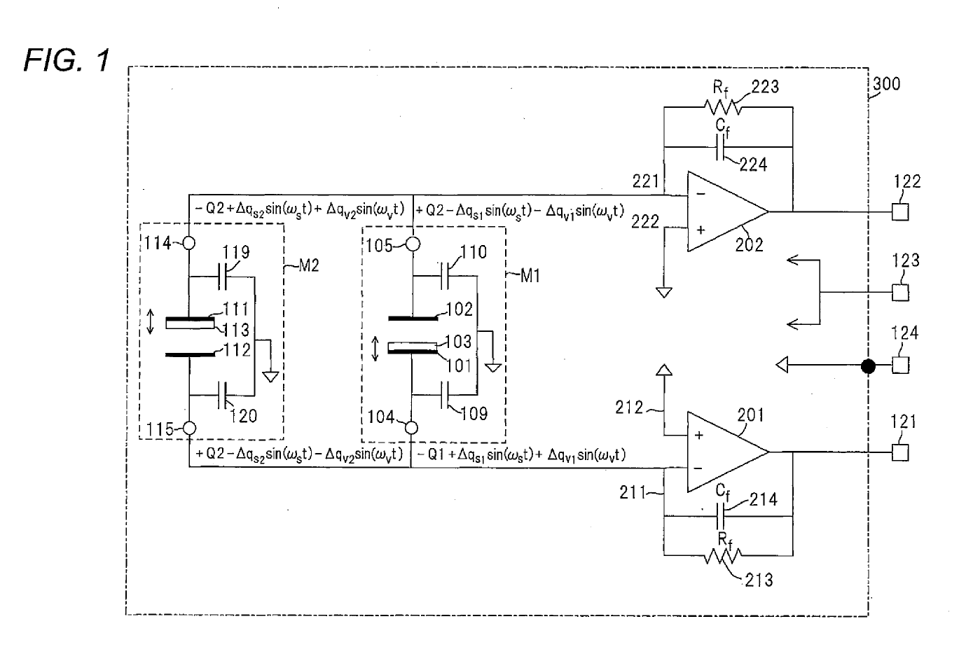

By reference to FIGS. 1 through 4, a first embodiment of the present invention is hereunder described in detail. Materials and numerals employed in the present invention are mere illustration of preferable examples, and the present invention is not limited to the embodiment. The present invention is susceptible to modifications, as required, within the scope of idea of the present invention. In addition, the embodiment can also be combined with another embodiment. A capacitance section of a capacitance microphone is an MEMS element section. In particular, explanations are hereunder provided on condition that the MEMS element section has an electret. As will be described later, the MEMS element section herein refers to a capacitor made by use of semiconductor processes. The above descriptions can be said to be common throughout the present invention.

FIG. 1 is a schematic diagram of an equivalent circuit diagram of the capacitance microphone of the first embodiment of the present invention.

As shown in FIG. 1, the capacitance microphone has a first capacitance section M1, a second capacitance section M2, a first amplifier 201, and a second amplifier 202.

The first capacitance section M1 is an MEMS element section that includes a first electrode 101 that is a movable electrode of the first capacitance section M1 and a second electrode 102 disposed opposite the first electrode 101. The first amplifier 201 is connected to the first electrode 101 of the first capacitance section M1 and amplifies a signal from the first electrode 101. The second amplifier 202 is connected to the second electrode 102 of the first capacitance section M1 and amplifies a signal from the second electrode 102. An electret film 103 holding permanent electric charges, is made over a surface of the first electrode 101 of the first capacitance section M1.

The second capacitance section M2 is an MEMS element section including a first electrode 111 that is a movable electrode of the second capacitance section M2 and a second electrode 112 disposed opposite the first electrode 111. The first amplifier 201 is connected to the second electrode 112 of the second capacitance section M2 and amplifiers a signal from the second electrode 112. The second amplifier 202 is connected to the first electrode 111 of the second capacitance section M2 and amplifies a signal from the first electrode 111. An electret film 113 holding permanent electric charges is made over a surface of the first electrode 111 of the second capacitance section M2.

When viewed from an input terminal 211 of the first amplifier 201 and an input terminal 221 of the second amplifier 202, the first capacitance section M1 and the second capacitance section M2 are connected in opposite polarity to each other.

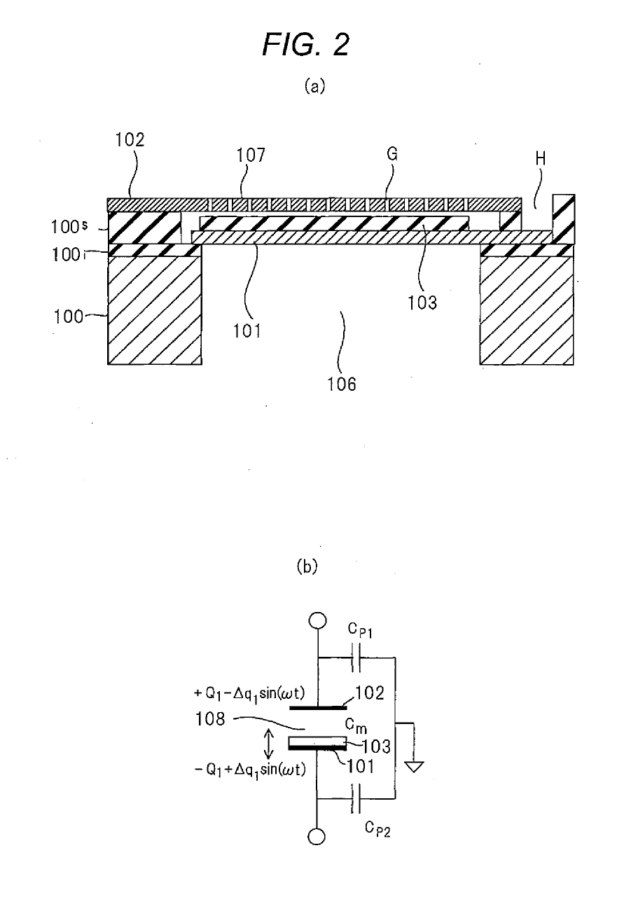

FIG. 2(a) is a cross sectional view of the MEMS element section of the first embodiment of the present invention, and FIG. 2(b) is a schematic diagram of a circuit diagram of the MEMS element section of the first embodiment of the present invention. The MEMS element section is made by simultaneously fabricating a plurality of microphone chips on a silicon substrate (a silicon wafer) by utilization of a CMOS (complementary field-effect transistor) manufacturing process technique and finally separating the microphone chips into discrete chips. FIG. 2(a) shows a cross sectional view of one of the thus-separated microphone chips.

As shown in FIG. 2(a), the MEMS element section has an n-type silicon substrate 100; a silicon oxide film 100i formed over the silicon substrate 100; the first electrode 101 that acts as a movable electrode fabricated on a surface of the silicon oxide film 100i; the electret film 103 made over a surface of the first electrode 101 (placed so as to be sandwiched between the first electrode 101 and the second electrode to be described later); a spacer 100s formed from a vitrified silicon film; the second electrode 102 acting as a stationary electrode supported by the spacer 100s; and a through hole 106 made by etching the silicon substrate 100. A plurality of pores 107 are formed in the second electrode; an air gap G is formed in a space sandwiched between the first electrode 101 and the second electrode 102; and a contact hole H for electrical connection is additionally provided. Alternatively, a silicon oxide film, a silicon nitride film, an electret film, and the like, may also be layered on or beneath the first electrode 101 and the second electrode 102, thereby making up a first film and a second film. A film having the first electrode that is the movable electrode can be called a vibrating film or a movable film, and the first film corresponds to the vibrating film or the movable film. The first electrode 101 and the second electrode 102 are formed from an n-doped polysilicon film, and the electret film 103 is a film formed by turning a silicon oxide film into an electret. The air gap G is formed by etching away an area where the spacer 100s has originally been made, through use of a semiconductor microfabrication technique such as wet etching. However, another technique can also be used. Further, the vibrating film formed from the first electrode is vibrated by an acoustic wave, whereby the MEMS element section acts as a capacitance section of a capacitance microphone. The first electrode 101 and the second electrode 102 act as a pair of capacitors.

An additional explanation is now given to the electret film 103. First, a plurality of MEMS element sections fabricated on a silicon substrate (a wafer) are separated into discrete chips. Subsequently, the thus-separated chips are subjected to electret processing, by means of a corona discharge, and the like, whereby a dielectric film is turned into an electret. As a result, the electret film 103 can be caused to hold electric charges. Needless to say, formation of an electret may also be performed in a wafer stage. Depending on a property of the electret film, the electret film is generally electrified with negative electric charges.

Since the electret film is formed from an inorganic film, such as a silicon oxide film and a silicon nitride film, the electret film is suitable for use as a sensor to be mounted by means of solder reflow when compared with an electret microphone utilizing a polymeric film, such as an FEP, because an electric charge holding property of the electret film is not deteriorated even when the electret film is exposed to a high temperature.

By reference to FIG. 2(b), a circuit diagram of the MEMS element section is now described. First electrode electric charges −Q₁[C] appear, as electric charges, on the first electrode 101 having an electret film, and second electrode electric charges +Q₁[C] appear, as electric charges, on the second electrode 102 that is an opposite electrode, whereby an equilibrium state is achieved.

In the equilibrium state, capacitance Cₘ made by the opposite electrodes depends on the air gap G and an area of the electrode, assuming a unique value.

### [Mathematical Expression 2]

$${c}_{m} = \frac{{ɛ}_{0} {ɛ}_{s} {S}_{dia}}{d} ,$$

where
∈₀: a dielectric constant of a vacuum 8.85E−12 [F/m]
∈_{S}: a relative permittivity of air 1.000586
S_{dia}: an area of an electrode (an area of a vibrating plate) [m²]
G: a gap length [m]

In addition, as represented by an equivalent circuit shown in FIG. 2(b), the capacitance Cₘ can be readily embodied as a floating structure on the silicon substrate 100 without being connected to a reference electric potential (a ground potential) (without being connected to a ground).

When in this equilibrium state a sinusoidal acoustic wave of a single angular frequency ωₛ is led to the first electrode 101 acting as a movable electrode, the first electrode causes sinusoidal vibrations at the same frequency as that of the acoustic wave. A magnitude of displacement of the microvibrations is generally determined by stiffness of the vibrating film.

The vibrations cause a change in capacitance in the equilibrium state, whereupon a change occurs in electric charges of both electrodes.

### [Mathematical Expression 3]

Provided that displacement of the micro-vibrations developed in the equilibrium state of the first electrode is taken as Δξ sin(ωₛt), complementary micro-changes occur in the electric charges at the same frequency.

First electrode electric charges: −Q₁+Δqₛ sin(ωₛₜ₎

Second electrode electric charges: +Q₁−Δqₛ sin(ωₛₜ₎

The micro-changes in electric charges are represented as micro-changes in voltage, as well.

### [Mathematical Expression 4]

There are defined as

First electrode voltage:

$$+ \frac{Δ {q}_{s} sin ( {ω}_{s} t )}{{C}_{m}}$$

Second electrode voltage:

$$\cdot - \frac{Δ {q}_{s} sin ( {ω}_{s} t )}{{C}_{m}}$$

Conversely, if changes are principally represented in terms of micro-changes in voltage, we have

### [Mathematical Expression 5]

First electrode electric charges: +CₘΔVₛ

Second electrode electric charges: −CₘΔVₛ.

As a result of presence of the floating structure, unique parasitic capacitance depending on the structure shown in FIG. 2(a) occurs. Parasitic capacitance 110 develops between the first electrode 101 and the silicon substrate 100. Further, parasitic capacitance 109 develops between the second electrode 102 and the silicon substrate 100. The parasitic capacitances are attributable to fixed objects, like support frames of the first electrode 101 and the second electrode and leads of the electrodes. Even when chips are mounted on a printed board by bonding, parasitic capacitance develops through a silicon substrate. The parasitic capacitance assumes a value that is not changed by the acoustic wave and vibrations. Therefore, variable electric charges (a voltage) that turn into a signal do not develop across the capacitance.

Therefore, the MEMS microphone chip is represented by an equivalent circuit, such as that shown in FIG. 2(b). Capacitance of the capacitance section is denoted by previously-described Cₘ; the first parasitic capacitance 109 is denoted by C_{P1}; and the second parasitic capacitance 110 is denoted by C_{P2}. Since the parasitic capacitance C_{P1} and the parasitic capacitance C_{P2} develop in wiring areas of the electrode, and the like, no vibrations occur in the parasitic capacitances, and hence electric charges are not caused by the parasitic capacitances. Namely, an electromotive voltage stemming from sound does not arise.

In relation to DC bias capacitance microphones, electret capacitance microphones, and electret MEMS microphones, a study of changes in electric charges developing across mutually-opposite electrodes, which have been described thus far, has never been discussed (see JP-2008-328492).

The DC bias capacitance microphones were conceived by E. C. Wente in the early 1900s. Since then, there has been employed a basic configuration and structure in which a polarized DC voltage is applied to any one of electrodes. Hence, the other electrode is inevitably connected to a reference electric potential (a ground potential). For this reason, signal charges flow into a ground line, and utilizing signal charges of both electrodes has never been conceived.

In the 1960s, G. M. Sessler turned a Teflon (Registered Trademark) film into an electret and applied the electret to a capacitance microphone. The capacitance microphone was introduced as an electret capacitance microphone and has widely been used in cell phones, and others, this day. Even such an electret capacitance microphone can be miniaturized, the microphone still holds the same basic configuration and structure as that of the DC bias capacitance microphone. Even in this case, when any one of electrodes is connected to a ground line (a ground potential), signal charges flow to the ground line, so that utilizing signal charges of both electrodes has never been conceived.

As above, the capacitance microphone of the first embodiment of the present invention is characterized in that the capacitance microphone can effectively utilize signal charges developed across electrodes of the capacitance section.

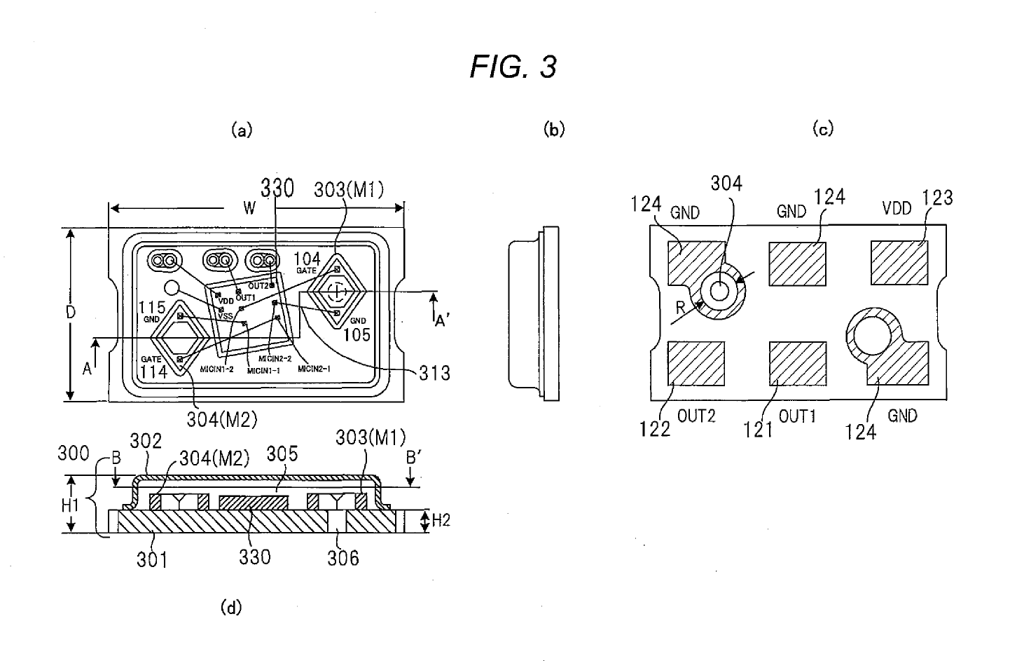

A mounting overview of the capacitance microphone of the first embodiment of the present invention is now described. FIGS. 3(a) to (d) are mounting overviews of the capacitance microphone of the first embodiment of the present invention.

FIG. 3(a) shows a top view of the capacitance microphone (module) whose metal cap remains removed. FIG. 3(b) shows a left side view of the capacitance microphone (module); FIG. 3(c) shows a bottom view of the capacitance microphone; and FIG. 3(d) shows a cross sectional view of the capacitance microphone. FIG. 3(d) shows a cross sectional view of the capacitance microphone taken along line A-A′ shown in FIG. 3(a). FIG. 3(a) is a view of a mount board when viewed from its cross section taken along line B-B′ shown in FIG. 3(d).

As shown in FIG. 3(a) to (d), the capacitance microphone is built such that a first capacitance section 303, a second capacitance section 304, and an amplifier 330 are housed in a container 300 made up of a printed board 301 and a metal cap (cover) 302. In the amplifier 330, a first amplifier and a second amplifier are built from a single IC (a connection between the first capacitance section 303 and the first and second amplifiers and a connection between the second capacitance section 304 and the first and second amplifiers are the same as those described in connection with FIG. 1, and hence their repeated explanations are omitted).

An openings(inlet pore) 306 for introducing sound and pressure is made in the printed board 301, and the first capacitance section 303 is laid over the opening 306 so as to cover the opening 306. In the meantime, the second capacitance section 304 is placed on an area of the printed board 301 where the openings are not made (in other words, the area of the printed board located beneath the second capacitance section 304 is closed).

An output terminal 121 of the first amplifier, an output terminal 122 of the second amplifier, a voltage supply terminal (a power input terminal) 123 for supplying a voltage to the first amplifier and the second amplifier, and a ground terminal 124 are placed on the other side of the printed board mounted with the first capacitance section 303, the second capacitance section 304, and the amplifier 330, whereby a surface mount terminal structure is formed. The surface mount terminal structure acts as an interface terminal for the outside. The printed board 301 and the metal cap 302 are bonded together by means of solder reflow, or the like. The first capacitance section 303, the second capacitance section 304, and the amplifier 330 are mounted and stuck to a first surface of the printed board 301 by means of an adhesive.

The amplifier 330 is a CMOS-type high input impedance amplifier having terminals MICIN1-1 and MICIN1-2 allocated to the input terminal of the first amplifier; terminals MICIN2-1 and MICIN2-2 allocated to the input terminal of the second amplifier; a terminal VDD connected to the voltage supply terminal; a terminal OUT1 allocated to the output terminal 121 of the first amplifier; a terminal OUT2 allocated to the output terminal 122 of the second amplifier; and a terminal VSS connected to a reference potential (a ground terminal). As mentioned previously, the terminals other than the input terminals act as terminals by way of which signals are exchanged with the outside and are connected to the terminals 121 to 124 provided on a second surface of the printed board 301. The ground terminal 124 is electrically connected to the metal cap 302 by way of the printed board 301, and the container 300 acts as a shielded container that has a ground potential and that protects the inside of the container from external electromagnetic noise.

A first electrode terminal 104 of the first capacitance section 303 is connected to the input terminal MICIN1-2 of the amplifier 330 by means of a bonding wire 313, and a second electrode terminal 105 of the first capacitance section 303 is connected to the input terminal MICIN2-2 of the amplifier 330 by means of the bonding wire 313.

An electrode terminal 114 of the second capacitance section 304 is connected to the input terminal MICIN2-1 of the amplifier 330 by means of the bonding wire 313, and an electrode terminal 115 of the second capacitance section 304 is connected to the input terminal MICIN1-1 of the amplifier 330 by means of the bonding wire 313.

The amplifier 330 has a subtraction function, like a function of subtracting an output signal of the second amplifier from an output signal of the first amplifier and may also have an additional amplifier. In this case, it is preferable for the amplifier 330 that the first amplifier, the second amplifier, and the third amplifier be built as a single IC.

Detailed explanations are now given to space 305 partitioned (defined) by the printed board 301, the metal cap 302, and the first capacitance section 303.

When pressure, like acoustic pressure, is introduced into the openings, space that is opposite to the openings with the movable electrode making up the first capacitance section sandwiched therebetween [i.e., space (defined) partitioned by the first capacitance section, the cover, and the substrate] acts as acoustic space. When compared with a case where only space located immediately above the first capacitance section acts as acoustic space, the volume of the acoustic space becomes greater; hence, stiffness (rigidity) of the space can be reduced. Consequently, the stiffness of the space can be made small than stiffness of the movable electrode of the first capacitance section and the stiffness of the movable electrode of the second capacitance section. Acoustic energy introduced by way of the openings travels to the movable electrode of the second capacitance section after having vibrated the movable electrode of the first capacitance section. When the volume of the acoustic space becomes greater, acoustic energy becomes easier to spread and dissipate in the acoustic space. Therefore, acoustic energy applied to the movable electrode of the second capacitance section becomes extremely smaller.

For these reasons, vibrations of the movable electrode of the second capacitance section caused by the acoustic energy become extremely smaller than vibrations of the movable electrode of the first capacitance section. This means that mutual interference of acoustic sensitivity is extremely small and that acoustic sensitivity of the microphone yielded by the acoustic energy is determined by the acoustic sensitivity of the first capacitance section.

In the meantime, consideration is now given to vibration energy stemming from vibration of the entire microphone. Since the first capacitance section and the second capacitance section are placed on a single substrate, acceleration of the same magnitude is exerted on the movable electrode of the first capacitance section and the movable electrode of the second capacitance section, respectively. Specifically, vibration energy of a single phase is afforded to the respective movable electrodes. For these reasons, the first capacitance section and the second capacitance section are connected, in opposite polarity, in parallel to each other. When combined with a capacitive coupling electric charge amplifier, which will be described later, the first and second capacitance sections can cancel a noise signal caused by the vibration energy.

As has been described above, in relation to acoustic energy, the acoustic sensitivity of the microphone is determined by the acoustic sensitivity of the first capacitance section, and the vibration energy is canceled. Therefore, sensitivity of the first capacitance section for pressure, such as acoustic pressure, can be enhanced, whereby the function of the microphone is improved. Accordingly, an increase in the volume of the acoustic space is understood to be desirable. Such a space 305 can also be called a shared space (a shared air chamber), because the space 305 shares a surrounding space of the first capacitance section 303 and a surrounding space of the second capacitance section 304 (and a space where a through hole of the second capacitance section is formed).

In the first embodiment of the present invention, it is conceived that the volume of the acoustic space 305 can be increased by positioning the opening 306 immediately below the first capacitance section 303. However, the position of the opening 306 is not limited to the point immediately below the first capacitance section 303. For instance, the opening 306 can also be placed at a point on the printed board that is not covered with the first capacitance section 303 and that deviates from the first capacitance section 303. Further, the opening 306 may also be placed in the vicinity of an upper side of the first capacitance section 303 of the metal cap 302. In the case, such as that mentioned above, a partition for separating the surrounding space of the first capacitance section 303 from the surrounding space of the second capacitance section 304 must be provided. With the partition, pressure, such as acoustic pressure, entered from the opening 306 is guided from a position above the first capacitance section 303, so that space located below the movable electrode of the first capacitance section 303 (i.e., space where the through hole is formed) becomes acoustic space. Since the partition is provided, pressure, such as acoustic pressure, does not arrive at the movable electrode of the second capacitance section 304. Thus, noise caused by vibration energy stemming from vibration of the entire microphone can be canceled in the manner as mentioned above. In the case of a configuration including an opening formed in a metal cap and another configuration including an opening formed in a position on the printed board displaced from the first capacitance section 303, the volume of the acoustic space becomes smaller. For this reason, it is preferable to make the opening in the printed board so as to cover the first capacitance section.

The first capacitance section 303 and the second capacitance section 304 measure 1.5 mm×1.2 mm, or thereabouts. Further, an IC making up the amplifier 330 is given a size of about 1.5 mm. When the first capacitance section 303, the second capacitance section 304, and the amplifier 330 are arranged as illustrated in FIG. 3, the container of the capacitance microphone measures about 6 mm (W)×3 mm (D)×1.3 mm (H), whereby sufficient space 305 can be assured. In this case, the volume of the space 305 comes to about 9.5E−9 [m³]. Further, stiffness S_{CB} of the space, which will be described later, comes to about 5 [N/M] from the viewpoint of circuits of an equivalent acoustic mechanism. Thus, considerably small stiffness is achieved.

By use of circuits of an equivalent acoustic mechanism and circuits of an equivalent vibratory mechanism, an explanation is now given to why the first capacitance section 303 comes to respond to sound and vibrations and the second capacitance section 304 comes to respond solely to vibrations as a result of use of the capacitance microphone of the first embodiment of the present invention.

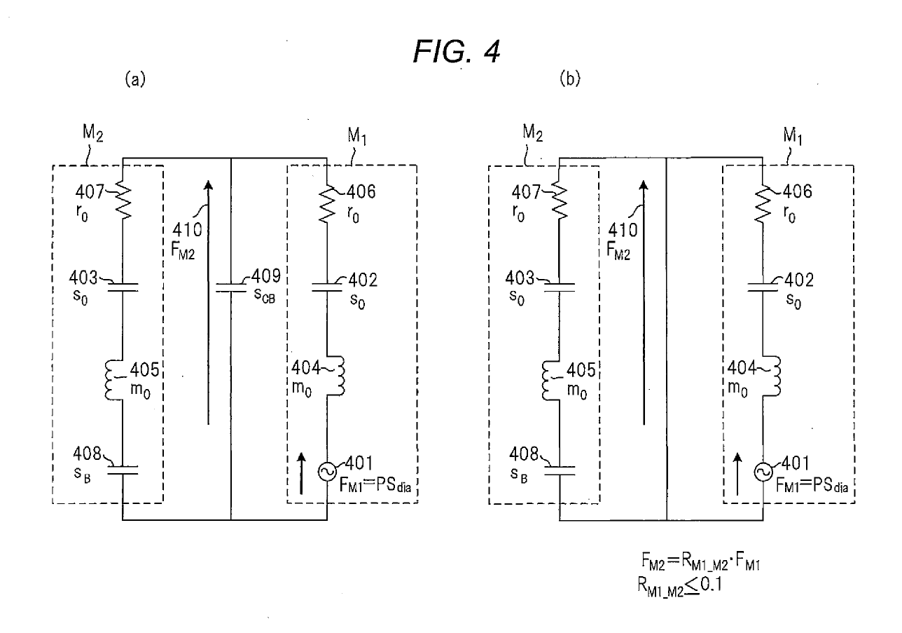

FIG. 4(a) is a circuit of an equivalent acoustic mechanism achieved when the first capacitance section is taken as M1, when the second capacitance section is taken as M2, and when an identical chip is used for each of M1 and M2.

A magnitude 401 of force exerted on the movable film having the first electrode (the movable electrode) when pressure, such as acoustic pressure, is introduced by way of the opening situated immediately below the first capacitance section is represented by

### [Mathematical Expression 6]

F_{M1}=PS_{dia}[N],

where

F_{M1}[N]: force exerted on the movable film of the first capacitance section

$$P [ \frac{N}{{m}^{2}} ] \text{:}$$

acoustic pressure introduced by way of the opening (acoustic pressure exerted on a microphone)

S_{dia} [m²]: an area of the movable film of the first capacitance section and an area of the movable member of the second capacitance section

Moreover, the following is derived in consideration of rigidity (stiffness) 402 of the movable film of the first capacitance section, rigidity (stiffness) 403 of the movable film of the second capacitance section, a mass 404 of the movable film of the first capacitance section, a mass 405 of the movable film of the second capacitance section, air resistance 406 of the air gap G of the first capacitance section, and air resistance 407 of the air gap G of the second capacitance section.

[Mathematical Expression 7]

$${s}_{0} [ \frac{{N}^{2}}{m} ] \text{:}$$

the rigidity 402 of the movable film of the first capacitance section, and the rigidity 403 of the movable film of the second capacitance section

m₀ [kg]: the mass 404 of the movable film of the first capacitance section, and mass 405 of the movable film of the second capacitance section

$${r}_{0} [ \frac{N sec}{m} ] \text{:}$$

the air resistance 406 of the air gap G of the first capacitance section, and air resistance 407 of the air gap G of the second capacitance section

Further, since the opening is not provided below the second capacitance section, space is formed from a through hole between the printed board and the second capacitance section. The space possesses spring rigidity. A magnitude 408 of the spring rigidity is represented by

### [Mathematical Expression 8]

$${s}_{B} = {S}_{dia}^{2} \frac{γ {P}_{0}}{{V}_{B \_ M 2}} [ \frac{N}{m} ] ,$$

where

γ: a specific heat ratio [Cp (specific heat at constant pressure)/Cv (specific heat at constant volume)]

$${P}_{0} [ \frac{{N}^{2}}{m} ] \text{:}$$

one static pressure=1013.25 [hPa]=1.01325E5 [Pa]=1.01325E5 [N/m²]

V_{B}_{_{—}}_{M2} [m³] a volume of a through hole of the second capacitance section

Rigidity 409 of space (designated by 305 in FIG. 3) defined by the printed board 301, the first capacitance section 303, the second capacitance section 304, and the metal cap 302 is expressed by

### [Mathematical Expression 9]

$${s}_{CB} = {S}_{dia}^{2} \frac{γ {P}_{0}}{{V}_{CB}} [ \frac{N}{m} ] ,$$

where

V_{CB} [m³]: a volume of space defined by the printed board 301, the first capacitance section 303, the second capacitance section 304, and the metal cap 302

It is also preferable to set the rigidity 409 by use of the volume so as to satisfy the following condition:

### [Mathematical Expression 10]

s_{CB}<<s₀,S_{B}

The term S_{CB} is preferably less than one-tenth of S₀ and less than one-tenth of S_{B}. When the relationship of S_{CB} 1/10·S_{B} is expressed in another way, it is preferable to set space that is defined by the printed board 301, the first capacitance section 303, the second capacitance section 304, and the metal cap 302, in such a way that the volume of the space becomes 10 times or more as large as the volume of the space closed by the second capacitance section 304 and the printed board 301 (a space of a lower portion of the movable electrode in the second capacitance section; in particular, space occupied by the through hole of the second capacitance section 304).

As a result of adoption of the conditions, it becomes possible to ignore the rigidity of the shared space defined by the printed board 301, the first capacitance section 303, and the metal cap 302 (make a mechanical acoustic short circuit in a circuit), so that the space can be dealt like a circuit of an equivalent acoustic mechanism, such as that shown in FIG. 4(b).

Force F_{M2} 410 of acoustic energy exerted on the movable film of the second capacitance section 304 can be made close to 0 [N/m²] by means of a mechanical acoustic short circuit or a value of (1/10)·(0.1) of F_{M1} 401 exerted on the movable film of the first capacitance section 303 or less.

Accordingly, an output from the first capacitance section M1 (303) serving as a microphone and an output from the second capacitance section M2 (304) serving as a microphone can be expressed as follows.

### [Mathematical Expression 11]

An acoustic signal output from M1:

$${V}_{M 1 \_ SOUND} [ V ] = {F}_{M 1} \cdot \frac{\frac{1}{{s}_{0}}}{G} \cdot {V}_{EB 1}$$

An acoustic signal output from M2:

$$\begin{matrix}{V}_{M 2 \_ SOUND} [ V ] = {F}_{M 2} \cdot \frac{\frac{1}{( {s}_{0} + {s}_{B} )}}{G} \cdot {V}_{EB 2} \\ = {R}_{M 1 \_ M 2} \cdot {F}_{M 1} \cdot \frac{\frac{1}{( {s}_{0} + {s}_{B} )}}{G} \cdot {V}_{EB 2}\end{matrix}$$

$${R}_{M 1 \_ M 2} = \frac{{F}_{M 2}}{{F}_{M 1}} = 0 ∼ 0.1$$

where V_{EB1}[V]: an electric potential of an electret caused by held electric charges −Q₁[C]
V_{EB2}[V]: an electric potential of an electret caused by held electric charges −Q₂[C]

In a vibration noise suppressing microphone of the present invention, the following relationship is given to acoustic sensitivity of M1 and M2, thereby accomplishing the same acoustic sensitivity level.

### [Mathematical Expression 12]

Acoustic sensitivity of M1:

$${S}_{dia} \frac{\frac{1}{{s}_{0}}}{G} \cdot {V}_{EB 1}$$

Acoustic sensitivity of M2:

$${S}_{dia} \frac{\frac{1}{( {s}_{0} + {s}_{B} )}}{G} \cdot {V}_{EB 2}$$

a relationship (an equation for controlling an electric potential of an electret)

As a result, there are derived an acoustic signal output of M1 and an acoustic signal output of M2 as follows:

$$\frac{1}{{s}_{0}} {V}_{EB 1} = \frac{1}{( {s}_{0} + {s}_{B} )} {V}_{EB 2}$$

$${V}_{EB 2} = \frac{( {s}_{0} + {s}_{B} )}{{s}_{0}} {V}_{EB 1}$$

### [Mathematical Expression 13]

An acoustic signal output of M1:

$${V}_{M 1 \_ SOUND} [ V ] = {F}_{M 1} \cdot \frac{\frac{1}{{s}_{0}}}{G} \cdot {V}_{EB 1}$$

An acoustic signal output of M2:

$$\begin{matrix}{V}_{M 2 \_ SOUND} [ V ] = {F}_{M 2} \cdot \frac{\frac{1}{( {s}_{0} + {s}_{B} )}}{G} \cdot {V}_{EB 2} \\ = {R}_{M 1 \_ M 2} \cdot {F}_{M 1} \cdot \frac{\frac{1}{{s}_{0}}}{G} \cdot {V}_{EB 1}\end{matrix}$$

$${R}_{M 1 \_ M 2} = 0 ∼ 0.1$$

When a control balance of the electric potential of the electret can be controlled within a value of ±5% and when consideration is given to a potential difference, an output of M2 can be expressed as follows:

### [Mathematical Expression 14]

$${V}_{M 2 \_ SOUND} [ V ] = {R}_{M 1 \_ M 2} \cdot {F}_{M 1} \cdot \frac{\frac{1}{{s}_{0}}}{G} \cdot {V}_{EB 1} ( 1 \pm {Δ}_{VEB} )$$

$${R}_{M 1 \_ M 2} = 0 ∼ 0.1$$

$${Δ}_{VEB} = 0.05 max$$

Because of its structure, the movable film of the second capacitance section causes vibrations that are reverse of vibrations of the movable film of the first capacitance section. Specifically, a phase difference of 180 degrees may occur between the vibrations of the movable film of the first capacitance section and the vibrations of the movable film of the second capacitance section.

From above, it can be safely said that the acoustic sensitivity of the capacitance microphone having the foregoing configuration can be taken as the acoustic sensitivity of M1 expressed below.

### [Mathematical Expression 15]

$${V}_{M 1 \_ sen} [ \frac{V}{( \frac{N}{{m}^{2}} )} ] = {S}_{dia} \cdot \frac{\frac{1}{{s}_{0}}}{G} \cdot {V}_{EB 1}$$

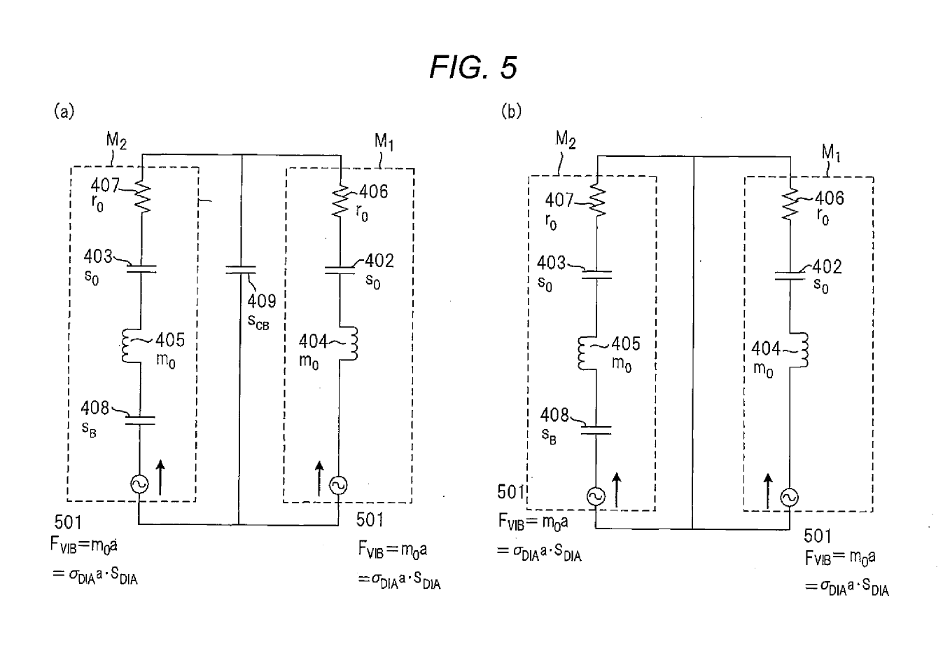

FIG. 5(a) is a circuit of an equivalent vibratory mechanism achieved when the first capacitance section is M1; when the second capacitance section is M2; and when an identical chip is used for each of the first and second capacitance sections.

Force acting on the movable film of the first capacitance section and force acting on the movable film of the second capacitance section become identical with each other by means of the vibration acceleration and expressed as follows.

### [Mathematical Expression 16]

F_{VIB}[N]=m₀·a=δ_{DIA}a·S_{DIA}

:Force 501 acting on the movable film by vibration acceleration

Conditions for stiffness of the space defined by the printed board, the first capacitance section, the second capacitance section, and the metal cap are defined as

### [Mathematical Expression 17]

s_{CB}<<s_{0,}s_{B}.

The conditions can be applied, as they are, to the circuit of the equivalent vibratory mechanism. It thereby becomes possible to ignore rigidity of the shared space defined by the printed board, the first capacitance section, and the metal cap, in terms of mechanical vibration (possible to make a short circuit in a circuit by means of mechanical vibrations). Thus, the shared space can be handled as a circuit of an equivalent vibratory mechanism, such as that shown in FIG. 5(b).

By means of the short circuit attributable to mechanical vibrations, the capacitance microphone becomes equivalent to a case where force F_{VIB} caused by vibration acceleration is independently exerted on the movable film of the first capacitance section and the movable film of the second capacitance section, so that an output produced by M1 because of the vibration acceleration and an output produced by M2 because of the same are expressed as follows.

### [Mathematical Expression 18]

Output produced by M1 because of vibration acceleration:

$${V}_{M 1 \_ VIB} [ V ] = {m}_{0} a \cdot \frac{\frac{1}{{s}_{0}}}{G} \cdot {V}_{EB 1} = {σ}_{DIA} a \cdot {S}_{DIA} \frac{\frac{1}{{s}_{0}}}{G} \cdot {V}_{EB 1}$$

Output produced by M2 because of vibration acceleration:

$$\begin{matrix}{V}_{M 2 \_ VIB} [ V ] = {m}_{0} a \cdot \frac{\frac{1}{( {s}_{0} + {s}_{B} )}}{G} \cdot {V}_{EB 2} \\ = {σ}_{DIA} a \cdot {S}_{DIA} \frac{\frac{1}{( {s}_{0} + {s}_{B} )}}{G} \cdot {V}_{EB 2}\end{matrix}$$

As mentioned above, the same acoustic sensitivity is achieved by controlling electric charge potentials in the capacitance microphone of the present invention. Therefore, the output produced by M2 because of vibration acceleration is expressed as follows.

### [Mathematical Expression 19]

$$\begin{matrix}{V}_{M 2 \_ VIB} [ V ] = {m}_{0} a \cdot \frac{\frac{1}{( {s}_{0} + {s}_{B} )}}{G} \cdot {V}_{EB 2} \\ = {m}_{0} a \cdot \frac{\frac{1}{( {s}_{0} + {s}_{B} )}}{G} \cdot \frac{( {s}_{0} + {s}_{B} )}{{s}_{0}} {V}_{EB 1} \\ = {m}_{0} a \cdot \frac{\frac{1}{{s}_{0}}}{G} \cdot {V}_{EB 1} \\ = {σ}_{DIA} a \cdot {S}_{DIA} \frac{\frac{1}{{s}_{0}}}{G} \cdot {V}_{EB 1}\end{matrix}$$

Thus, the output comes to the same value as that of the output produced by M1 because of vibration acceleration. Thus, both of the outputs resultant of vibration acceleration become proportional to acoustic sensitivity.

As mentioned above, control balance of charge potentials can be accomplished with a range of ±5%. When the charge potentials are taken into consideration, the output produced by M2 because of vibration acceleration is expressed as follows.

### [Mathematical Expression 20]

$${V}_{M 2 \_ VIB} [ V ] = {σ}_{DIA} a \cdot {S}_{DIA} \frac{\frac{1}{{s}_{0}}}{G} {V}_{EB 1} ( 1 \pm {Δ}_{VEB} )$$

$${Δ}_{VEB} = 0.05 max$$

As has been described, an electric charge (voltage) of the first electrode and an electric charge (voltage) of the second electrode of the first capacitance section and an electric charge (voltage) of the first electrode and an electric charge (voltage) of the second electrode of the second capacitance section are expressed as below.

### [Mathematical Expression 21]

The electric charge of the first electrode of the first capacitance section:

$$+ Δ {q}_{s 1} sin ( {ω}_{s} t ) + Δ {q}_{v 1} sin ( {ω}_{v } t ) = + {C}_{m} \cdot {PS}_{dia} \frac{\frac{1}{{s}_{0}}}{G} {V}_{EB 1} sin ( {ω}_{s} t ) + {C}_{m} \cdot {m}_{0} a \frac{\frac{1}{{s}_{0}}}{G} {V}_{EB 1} sin ( {ω}_{v} t )$$

The electric charge of the second electrode of the first capacitance section:

$$- Δ {q}_{s 1} sin ( {ω}_{s} t ) - Δ {q}_{v 1} sin ( {ω}_{v } t ) = - {C}_{m} \cdot {PS}_{dia} \frac{\frac{1}{{s}_{0}}}{G} {V}_{EB 1} sin ( {ω}_{s} t ) - {C}_{m} \cdot {m}_{0} a \frac{\frac{1}{{s}_{0}}}{G} {V}_{EB 1} sin ( {ω}_{v} t )$$

The electric charge of the first electrode of the second capacitance section:

$$+ Δ {q}_{s 2} sin ( {ω}_{s} t ) + Δ {q}_{v 2} sin ( {ω}_{v } t ) = + {C}_{m} ( - {R}_{M 1 \_ M 2} \cdot {PS}_{dia} \frac{\frac{1}{{s}_{0}}}{G} {V}_{EB 1} ( 1 \pm {Δ}_{VEB} ) ) sin ( {ω}_{s} t ) + Cm \cdot {m}_{0} a \frac{\frac{1}{{s}_{0}}}{G} {V}_{EB 1} ( 1 \pm {Δ}_{VEB} ) sin ( {ω}_{v} t ) = - {C}_{m} \cdot P \cdot {S}_{dia} \frac{\frac{1}{{s}_{0}}}{G} {V}_{EB 1} {R}_{M 1 \_ M 2} ( 1 \pm {Δ}_{VEB} ) sin ( {ω}_{s} t ) + Cm \cdot {σ}_{DIA} a \cdot {S}_{DIA} \frac{\frac{1}{{s}_{0}}}{G} {V}_{EB 1} ( 1 \pm {Δ}_{VEB} ) sin ( {ω}_{v} t )$$

(the reason for a negative sign is that vibrations of the vibrating plate are reversed for the case of acoustic energy)
The electric charge of the second electrode of the second capacitance section:

$$- Δ {q}_{s 2} sin ( {ω}_{s} t ) - Δ {q}_{v 2} sin ( {ω}_{v } t ) = - {C}_{m} ( - {R}_{M 1 \_ M 2} \cdot {PS}_{dia} \frac{\frac{1}{{s}_{0}}}{G} {V}_{EB 1} ( 1 \pm {Δ}_{VEB} ) ) sin ( {ω}_{s} t ) - Cm \cdot {m}_{0} a \frac{\frac{1}{{s}_{0}}}{G} {V}_{EB 1} ( 1 \pm {Δ}_{VEB} ) sin ( {ω}_{v} t ) = + {C}_{m} \cdot P \cdot {S}_{dia} \frac{\frac{1}{{s}_{0}}}{G} {V}_{EB 1} {R}_{M 1 \_ M 2} ( 1 \pm {Δ}_{VEB} ) sin ( {ω}_{s} t ) - Cm \cdot {σ}_{DIA} a \cdot {S}_{DIA} \frac{\frac{1}{{s}_{0}}}{G} {V}_{EB 1} ( 1 \pm {Δ}_{VEB} ) sin ( {ω}_{v} t )$$

(the reason for a negative sign is that vibrations of the vibrating plate are reversed for the case of acoustic energy)
where ω_{S} is an angular frequency of a sound source; and where ω_{V} is an angular frequency of a vibratory source.

A configuration of a reading circuit that can effectively utilize signal charges of both electrodes is hereinbelow described by reference to FIG. 1.

The first electrode 101 of the first capacitance section is connected to the inverting input terminal 211 of the first amplifier 201 by way of the first electrode terminal 104, thereby making up an inverting capacitive coupling amplifier. In the meantime, the second electrode 102 of the first capacitance section is connected to the inverting input terminal 221 of the second amplifier 202 by way of the second electrode terminal 105, thereby likewise making up an inverting capacitive coupling electric charge amplifier.

The first electrode 111 of the second capacitance section is connected to the inverting input terminal 221 of the second amplifier 202 by way of the first electrode terminal 114, thereby making up an inverting capacitive coupling amplifier. In the meantime, the second electrode 112 of the second capacitance section is connected to the inverting input terminal 211 of the first amplifier 201 by way of the second electrode terminal 115, thereby likewise making up an inverting capacitive coupling electric charge amplifier.

When viewed from the input terminals 211 and 221, the electrodes of the first and second capacitance sections are connected in opposite polarity.

It is desirable that the first amplifier 201 and the second amplifier 202 will have the same capability; however, chips cut from a single wafer can also be used for the first and second amplifiers 201 and 202. Alternatively, the first and second amplifiers 201 and 202 can also be fabricated in an integrated fashion on a single substrate.

Non-inverting input terminals 212 and 222 are connected to a reference electric potential (a ground potential).

The electret film 103 holding permanent electric charges is made over the first electrode 101 of the first capacitance section, and the electret film 113 holding permanent electric charges is made over the first electrode 111 of the second capacitance section.

As mentioned above, the first electrode 101 and the second electrode 102 of the first capacitance section respectively have the static capacitors 109 and 110 ascribable to structural and mounting factors. On the other hand, the first electrode 111 and the second electrode 112 of the second capacitance section respectively have static capacitors 119 and 120 ascribable to structural and mounting factors.

The first amplifier 201 and the second amplifier 202 are high input impedance amplifiers. In order to accomplish high input impedance, CMOS impedance amplifiers are desirable.

Although two power sources; namely, a positive power source and a negative power source, can be used as an operating power source, a high input impedance CMOS amplifier that operates on a single power source is desirable.

Feedback resistors 213 and 223 are discharge resistors for preventing saturation of the first amplifier 201 and the second amplifier 202. Further, feedback capacitors 214 and 224 determine a degree of amplification of electric charges (voltage). The feedback resistors are fabricated from ON resistance of the MOS in a MOS integrated circuit.

An output from the first amplifier 201 is guided to the output terminal 121 for external connection use, and an output from the second amplifier 202 is guided to the output terminal 122 for external connection use.

The terminal 123 is one for supplying a voltage to the amplifier (a power supply terminal), and the terminal 124 provides a reference potential (a ground terminal). The ground terminal 124 is also connected to the container 300 (see FIG. 3) that doubles also as a shield, thereby lessening inclusion of electromagnetic external noise.

In the first amplifier 201 that is an inverting capacitive coupling electric charge amplifier, a virtual short circuit occurs between the inverting input terminal 211 and the noninverting input terminal 212, as in an ordinary inverting amplifier. Likewise, in the second amplifier 202 that is also an inverting capacitive coupling electric charge amplifier, a virtual short circuit occurs between the inverting input terminal 221 and the noninverting input terminal 222, as in an ordinary inverting amplifier.

Input impedance of the inverting input terminals 211 and 221 becomes infinite because of such a virtual short circuit; hence, an electric current will not flow into the terminals.

Because of the virtual short circuit, the second electrode terminal 105 of the first capacitance section and the first electrode terminal 114 of the second capacitance section are virtually grounded, and the second amplifier 202 does not affect the first amplifier 201.

Likewise, the first electrode terminal 104 of the first capacitance section and the second electrode terminal 115 of the second capacitance section are virtually grounded, and the first amplifier 201 does not affect the second amplifier 202.

Accordingly, electric charges on the first electrode 101 of the first capacitance section and electric charges on the second electrode 112 of the second capacitance section flow into the feedback capacitor 214 and the feedback resistor 213.

Likewise, electric charges on the second electrode 102 of the first capacitance section and electric charges on the first electrode 111 of the second capacitance section flow into the feedback capacitor 224 and the feedback resistor 223.

Provided that a capacitance value of the feedback capacitors 214 and 224 is taken as C_{f} and that a feedback resistance value of the feedback resistors 213 and 214 is taken as R_{f}, expressed as follows are output voltages of the output terminals 121 and 122 produced in the configuration of the inverting capacitive coupling electric charge amplifiers that employs the first capacitance section and the second capacitance section are taken as signal sources.

### [Mathematical Expression 22]

A signal output from the output terminal 121:

$$- \frac{1}{{C}_{f}} \{ + Δ {q}_{s 1} sin ( {ω}_{s} t ) + Δ {q}_{v 1} sin ( {ω}_{v } t ) \} - \frac{1}{{C}_{f}} \{ - Δ {q}_{s 2} sin ( {ω}_{s} t ) - Δ {q}_{v 2} sin ( {ω}_{v } t ) \} = - \frac{{C}_{m}}{{C}_{f}} \{ {PS}_{dia} \frac{\frac{1}{{s}_{0}}}{G} {V}_{EB 1} sin ( {ω}_{s} t ) + {m}_{0} a \frac{\frac{1}{{s}_{0}}}{G} {V}_{EB 1} sin ( {ω}_{v} t ) \} - \frac{{C}_{m}}{{C}_{f}} \{ {PS}_{dia} \frac{\frac{1}{{s}_{0}}}{G} {V}_{EB 1} {R}_{M 1 \_ M 2} ( 1 \pm {Δ}_{VEB} ) sin ( {ω}_{s} t ) - {m}_{0} a \frac{\frac{1}{{s}_{0}}}{G} {V}_{EB 1} ( 1 \pm {Δ}_{VEB} ) sin ( {ω}_{v} t ) \} = - \frac{{C}_{m}}{{C}_{f}} {PS}_{dia} \frac{\frac{1}{{s}_{0}}}{G} {V}_{EB 1} \{ 1 + {R}_{M 1 \_ M 2} ( 1 \pm {Δ}_{VEB} ) sin ( {ω}_{s} t ) - \frac{{C}_{m}}{{C}_{f}} {m}_{0} a \frac{\frac{1}{{s}_{0}}}{G} {V}_{EB 1} \{ 1 - ( 1 \pm {Δ}_{VEB} ) \} sin ( {ω}_{v } t ) = - \frac{{C}_{m}}{{C}_{f}} \cdot P \cdot {S}_{dia} \frac{\frac{1}{{s}_{0}}}{G} {V}_{EB 1} \cdot \{ 1 + {R}_{M 1 \_ M 2} + {R}_{M 1 \_ M 2} \cdot {Δ}_{VEB} \} sin ( {ω}_{s} t ) - \frac{{C}_{m}}{{C}_{f}} \cdot {σ}_{DIA} a \cdot {S}_{DIA} \frac{\frac{1}{{s}_{0}}}{G} {V}_{EB 1} \cdot {Δ}_{VEB} \cdot sin ( {ω}_{v} t )$$

When the space 305 (see FIG. 3) is considerably large and when the charge potential is sufficiently controlled,

### [Mathematical Expression 23]

R_{M1}_{_{—}}_{M2}≈0

and

Δ_{VEB}≈0

can be defined.
Accordingly, the signal output from the output terminal 121 is expressed as follows.

$$- \frac{{C}_{m}}{{C}_{f}} {PS}_{dia} \frac{\frac{1}{{s}_{0}}}{G} {V}_{EB 1} sin ( {ω}_{s} t )$$

As a result, a collective acoustic signal that does not include any vibration noise signal (i.e., a collective acoustic signal that is completely free of vibration noise) can be acquired as an output.

So long as the charge potential falls within a range of ±5% as mentioned above, the signal output of the output terminal 121 is defined as below.

### [Mathematical Expression 24]

$$- \frac{{C}_{m}}{{C}_{f}} \cdot P \cdot {S}_{dia} \frac{\frac{1}{{s}_{0}}}{G} {V}_{EB 1} sin ( {ω}_{s} t ) - \frac{{C}_{m}}{{C}_{f}} \cdot {σ}_{DIA} a \cdot {S}_{DIA} \frac{\frac{1}{{s}_{0}}}{G} {V}_{EB 1} \cdot {0.05}_{( max )} \cdot sin ( {ω}_{v } t )$$

A vibration noise signal of the capacitance microphone having the above configuration is output while suppressed to a one-twentieth or less of a vibration noise signal output by a microphone not having a suppression configuration.

A signal output of the output terminal 122:

$$- \frac{1}{{C}_{f}} \{ - Δ {q}_{s 1} sin ( {ω}_{s} t ) - Δ {q}_{v 1} sin ( {ω}_{v } t ) \} - \frac{1}{{C}_{f}} \{ + Δ {q}_{s 2} sin ( {ω}_{s} t ) + Δ {q}_{v 2} sin ( {ω}_{v } t ) \} = + \frac{{C}_{m}}{{C}_{f}} \{ {PS}_{dia} \frac{\frac{1}{{s}_{0}}}{G} {V}_{EB 1} sin ( {ω}_{s} t ) + {m}_{0} a \frac{\frac{1}{{s}_{0}}}{G} {V}_{EB 1} sin ( {ω}_{v} t ) \} + \frac{{C}_{m}}{{C}_{f}} \{ {PS}_{dia} \frac{\frac{1}{{s}_{0}}}{G} {V}_{EB 1} {R}_{M 1 \_ M 2} ( 1 \pm {Δ}_{VEB} ) sin ( {ω}_{s} t ) - {m}_{0} a \frac{\frac{1}{{s}_{0}}}{G} {V}_{EB 1} ( 1 \pm {Δ}_{VEB} ) sin ( {ω}_{v} t ) \} = + \frac{{C}_{m}}{{C}_{f}} {PS}_{dia} \frac{\frac{1}{{s}_{0}}}{G} {V}_{EB 1} \{ 1 + {R}_{M 1 \_ M 2} ( 1 \pm {Δ}_{VEB} ) \} sin ( {ω}_{s} t ) + \frac{{C}_{m}}{{C}_{f}} {m}_{0} a \frac{\frac{1}{{s}_{0}}}{G} {V}_{EB 1} \{ 1 - ( 1 \pm {Δ}_{VEB} ) \} sin ( {ω}_{v } t ) = + \frac{{C}_{m}}{{C}_{f}} {PS}_{dia} \frac{\frac{1}{{s}_{0}}}{G} {V}_{EB 1} \cdot \{ 1 + {R}_{M 1 \_ M 2} + {R}_{M 1 \_ M 2} {Δ}_{VEB} \} sin ( {ω}_{s} t ) + \frac{{C}_{m}}{{C}_{f}} \cdot {σ}_{DIA} a \cdot {S}_{DIA} \frac{\frac{1}{{s}_{0}}}{G} {V}_{EB 1} \cdot {Δ}_{VEB} \cdot sin ( {ω}_{v} t )$$

When the space 305 (see FIG. 3) is considerably large and when the charge potential is sufficiently controlled, R_{M1}_{_{—}}_{M2}≈0 and Δ_{VEB}≈0 can be defined.

### [Mathematical Expression 25]

Accordingly, the signal output from the output terminal 122 is expressed as follows.

$$+ \frac{{C}_{m}}{{C}_{f}} \cdot P \cdot {S}_{dia} \frac{\frac{1}{{s}_{0}}}{G} {V}_{EB 1} sin ( {ω}_{s} t )$$

As a result, a collective acoustic signal that does not include any vibration noise signal (i.e., a collective acoustic signal that is completely free of vibration noise) can be acquired as an output.

So long as the charge potential falls within a range of ±5% as mentioned above, the signal output of the output terminal 122 is defined as below.

### [Mathematical Expression 26]

$$+ \frac{{C}_{m}}{{C}_{f}} \cdot P \cdot {S}_{dia} \frac{\frac{1}{{s}_{0}}}{G} {V}_{EB 1} sin ( {ω}_{s} t ) + \frac{{C}_{m}}{{C}_{f}} \cdot {σ}_{DIA} a \cdot {S}_{DIA} \frac{\frac{1}{{s}_{0}}}{G} {V}_{EB 1} \cdot {0.05}_{( max )} \cdot sin ( {ω}_{v } t )$$

A vibration noise signal of the capacitance microphone having the above configuration is output while suppressed to a one-twentieth or less of a vibration noise signal output by a microphone not having a suppression configuration.

As is seen from the above expression, because of the configuration, only collective acoustic signals that are of the same magnitude and opposite in phase to each other are output to the two output terminals 121 and 122 when the space 305 is considerably large and when the charge potential is sufficiently controlled.

Even when a difference (that falls within the foregoing range of ±5%) exists in charge potential, a vibration noise signal suppressed to a value of one-twentieth or less and a deterioration-free collective acoustic signal appear in opposite phase at the two output terminals 121 and 122.

The capacitance microphone can also exhibit a characteristic of producing a signal that is twice as large as that produced by a related art capacitance microphone whose one electrode is grounded, so long as the capacitance microphone subjects the two signals to balanced connection processing (subtraction processing). Subtraction can also be performed by installing a third amplifier having a subtraction capability into the capacitance microphone.

Since a low-pass cutoff filter that can be determined by a feedback resistor and a feedback capacitor are formed, the above-mentioned expression stands in a frequency range that is higher than a cutoff frequency fₒᵤₜ to be described below. The low-pass cutoff frequency fₒᵤₜ can be determined in consideration of an operation band of a vibration-noise-suppressed electret MEMS microphone.

### [Mathematical Expression 27]

Low-pass cutoff frequency:

$${f}_{cut} = \frac{1}{2 π {C}_{f} {R}_{f}} [ Hz ]$$

Signal electric charges do not appear on terminals of the fixed capacitors 109, 110, 119, and 120 as mentioned previously, the electric charges do not appear in outputs.

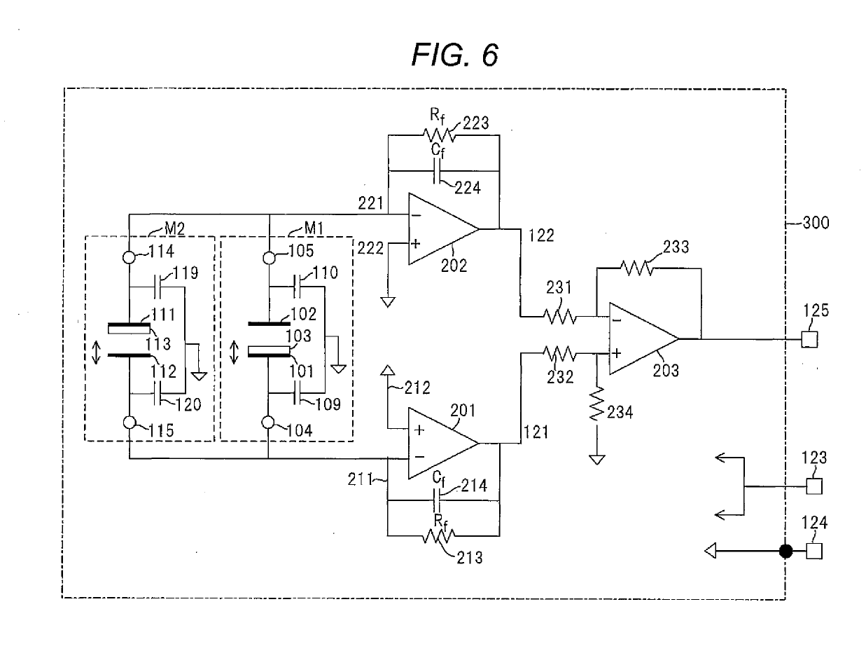

Actual characteristic measurement is performed by means of a configuration of FIG. 6 in which a third amplifier 330 having the foregoing subtraction capability is incorporated in the prototype IC.

FIG. 6 is a diagram made by adding to the elements shown in FIG. 1 a third amplifier 203 having a subtraction capability, resistors 231, 232, 233, and 234 that determine a degree of amplification, and an output terminal 125 for a subtraction output signal.

Measurement is performed by use of an electret MEMS microphone chip as the first capacitance section M1 and the second capacitance section M2 and a capacitor having 1 pF for Cₘ.

The first and second capacitance sections M1 and M2 make up identical electret MEMS microphone chips. In order to make the microphone chips equal as mentioned above in terms of acoustic sensitivity, an electret potential of the first capacitance section M1 is set to −9V, and an electret potential of the second capacitance section M2 is set to −15V. The following equation is embodied.

### [Mathematical Expression 28]

$${V}_{EB 2} = \frac{( {s}_{0} + {s}_{B} )}{{s}_{0}} {V}_{EB 1}$$

The amplifier 330 used herein is built from a prototype IC. In the IC, C_{f} of the amplifiers 201 and 202 is 2.56 pF, and a gain of the subtraction amplifier 203 is set to 0.5 from the resistors 231, 232, 233, and 234.

The feedback resistors 213 and 223 are set in such a way that the low-pass cutoff frequency comes to about 3 Hz.

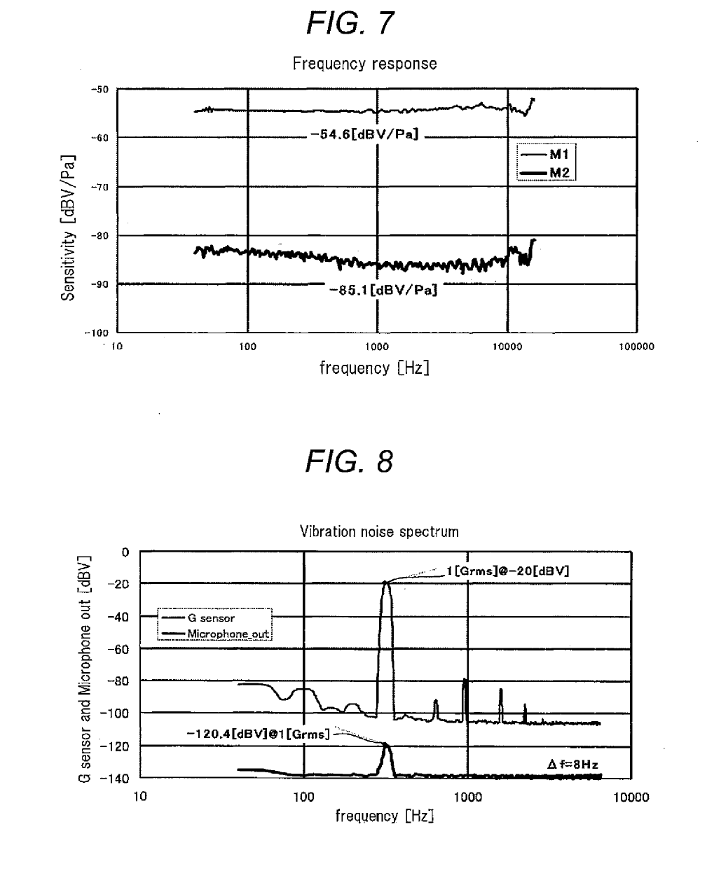

FIG. 7 shows a measurement result (an acoustic sensitivity frequency characteristic) of the microphone having the configuration shown in FIG. 6 in relation to acoustic sensitivity (the vertical axis) with respect to a frequency (the horizontal axis). In FIG. 7, acoustic sensitivity of the capacitance section M1 making up the MEMS microphone chip is represented as M1, and acoustic sensitivity of the capacitance section M2 making up the MEMS microphone chip is represented as M2. A reference is made to FIG. 3 for appearance of the microphone.

As can be seen from FIG. 7, acoustic sensitivity of M1 is −54.6 [dBV/Pa], and acoustic sensitivity of M2 is −85.1 [dBV/Pa]. In addition, for reasons of an effect of the large shared space 305 (see FIG. 3), acoustic energy applied to M2 is understood to become smaller than acoustic energy applied to M1 by a value of about 30 dB (about one-thirtieth). The reason for this is that the following relationship is satisfied.

### [Mathematical Expression 29]

s_{CB}<<S₀, S_{B}

From above, it is understood that acoustic sensitivity of the capacitance microphone having the configuration is determined by M1. The frequency characteristic is sufficiently flat for the microphone.

FIG. 8 shows measurement results of outputs (represented by the vertical axis) of the microphone having the configuration, such as that shown in FIG. 6, obtained when output signals of the microphone are subjected to FFT frequency analysis (hereinafter abbreviated as “FFT”) with reference to a frequency (the horizontal axis). In order to measure FFT outputs produced from the output signal of the microphone, a microphone and an acceleration sensor serving as an acceleration monitor are attached onto a compact vibration exciter, and vibratory acceleration having a single frequency of 320 Hz is applied to the compact vibration exciter.

### [Mathematical Expression 30]

$$a = 9.8 [ \frac{m}{{sec}^{2}} ] = 1 [ {G}_{rms} ]$$

Therefore, FIG. 8 also shows an FFT output from the acceleration sensor that serves as an acceleration monitor. An FFT output from the acceleration sensor is represented as Gsensor, and an FFT output of the microphone is represented as Microphone_out. A reference is made to FIG. 3 for appearance of the microphone.
As can be seen from FIG. 8, the amplifier of the acceleration sensor is adjusted in such a way that an output of −20[dBV] is produced at vibration acceleration of 1 [Gᵣₘₛ]. Accordingly, it is seen that the microphone is excited at an acceleration of 1 [Gᵣₘₛ]. An output from the acceleration sensor and an output from the microphone produced at a frequency that is “n” times as high as 320 Hz are caused by nonlinear response of the exciter. Both outputs are smaller than a fundamental wave of 320 Hz by an amount of 60 dB or more, and distortion of each of the outputs is 1% or less. Further, a measurement system is provided with soundproof means in such a way that sound originating from the exciter does not enter the microphone to be measured.

An output from the microphone produced at a vibration acceleration achieved at a single frequency of 320 Hz in such a measurement environment is −120.4 [dBV] as a vibration noise output at the same frequency. Thus, the vibration noise output has become considerably smaller when compared with the foregoing acoustic sensitivity of −54.6 [dBV/Pa].

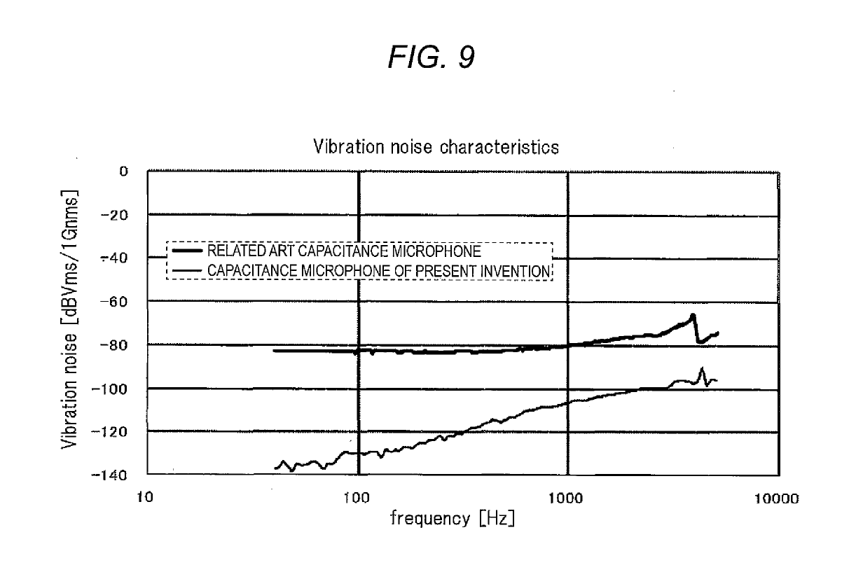

In order to compare the microphone having a configuration, such as that shown in FIG. 6, with a microphone having a related art configuration (not provided with a vibration noise suppression configuration), vibration noise outputs (the vertical axis) achieved at respective frequencies (the horizontal axis) are shown in FIG. 9.

Specifically, a vibration noise output of the related art microphone and a vibration noise output of the vibration noise suppression microphone were measured by sweeping a frequency of an input signal to the vibration exciter while a vibration acceleration was held at 1[Grms].

An output from the vibration noise suppression microphone of the present invention is 1/10 to 1/100 or less of the vibration noise output from the related art microphone, which shows that a vibration noise output suppression effect of the present invention is considerably large.

### Second Embodiment

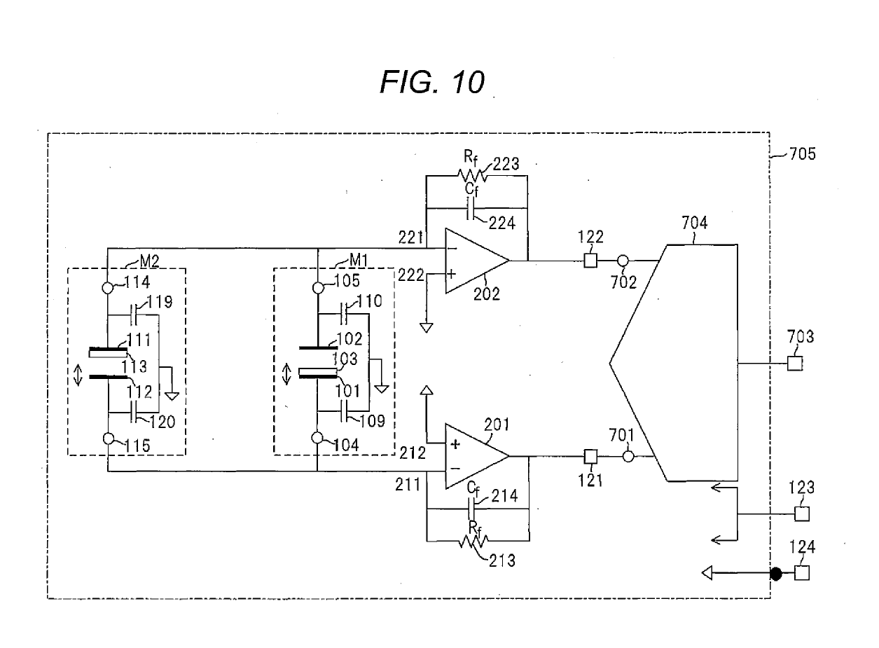

A second embodiment of the present invention is hereunder described in detail by reference to FIG. 10.

Materials and numerical values employed in the present invention are mere illustration, and the present invention is not limited to the illustrated mode. The present invention is susceptible to modifications, as required, without departing the scope of concept of the present invention. In addition, the present embodiment can also be used in combination with another embodiment. The capacitance section of the capacitance microphone is an MEMS element section and explained especially as an MEMS element section having an electret. As will be described later, the MEMS element section designates a capacitor fabricated by use of semiconductor processes. The above can also be said commonly through the present invention.

FIG. 10 is a schematic diagram of an equivalent circuit of a capacitance microphone of the second embodiment of the present invention.

As shown in FIG. 10, the capacitance microphone of the second embodiment of the present invention has a configuration produced by addition of an analogue-to-digital converter 704 to the configuration shown in FIG. 1. The output terminal 121 of the first amplifier 201 is connected to an input terminal 701 of an analogue-digital converter 704. The output terminal 122 of the second amplifier 202 is connected to an input terminal 702 of the analogue-digital converter 704. An output from the analogue-digital converter is led to a digital output terminal 703.

The analogue-digital converter 704 is structured so as to be placed within the container 300 made up of the printed board 301 and the metal cap 302, such as that described by reference to FIG. 3. In FIG. 10, a description is provided while reference numeral 705 designates a container.

The analogue-digital converter 704, the first amplifier 201, and the second amplifier 202 can be configured in one chip by utilization of the same manufacturing processes. The analogue-digital converter 704, the first amplifier 201, and the second amplifier 202 are preferably fabricated as an IC; in other words, a single IC. Further, the voltage supply terminal (the power supply terminal) 123 and the ground terminal 124 can be made common. By adoption of such a configuration, the analogue-digital converter 704 and the common circuit built from the first amplifier 201 and the second amplifier 202 (e.g., a low voltage generation circuit) can be assembled into a single piece, whereby a reduction in power consumption and chip size can be accomplished. Therefore, a cheaper microphone can be provided.

The analogue-digital converter 704 is preferably a Δ sigma modulator characterized by high resolution. In particular, when there is used a four-order Δ sigma modulator having a clock frequency of 1 MHz to 4 MHz and a 50 to 64-times over-sampling rate, a high signal-to-noise ratio can be accomplished at lower power consumption.

The output terminal 703 produces a PDM (Pulse Density Modulation) output showing a waveform, according to a pulse density having a given width. An external DSP (Digital Signal Processor) converts the output into an audio interface format; for instance, an SPDIF format. By virtue of the DSP being incorporated into the container 705, the output terminal 703 can also produce an output in an audio interface format; for instance, an SPDIF format.

As described in connection with the first embodiment, since a vibration noise suppression ratio achieved at the output terminals 121 and 122 that produce a balanced signal is enhanced, the output terminals 121 and 122 that output a balanced signal are connected to the input terminals 701 and 702 of the analogue-to-digital converter 704, respectively. As a result, a vibration noise suppression ratio of the microphone additionally provided with the analogue-digital-converter is also enhanced, so that a digital output signal having higher quality can be supplied.

The disclosure of Japanese Patent Application No. 2009-135247 filed on Jun. 4, 2009, the entire subject matter of which is incorporated herein by reference.

Since the microphone of the present invention can provide a collective acoustic signal having higher quality, a vibration suppression effect can be yielded particularly when the microphone is mounted in a portable phone, a PDA, and a game machine including a rigid substrate on which the microphone is to be mounted.

What is claimed is:

1. A microphone comprising:
a first capacitance section and a second capacitance section that each have a first electrode which is a movable electrode and a second electrode which is disposed opposite the first electrode;
a first amplifier that amplifies a signal from the first electrode of the first capacitance section and a signal from the second electrode of the second capacitance section; and
a second amplifier that amplifies a signal from the second electrode of the first capacitance section and a signal from the first electrode of the second capacitance section.

2. The microphone according to claim 1, further comprising:
a substrate on which the first capacitance section, the second capacitance section, the first amplifier, and the second amplifier are arranged;
a cover arranged on the substrate so as to cover the first capacitance section, the second capacitance section, the first amplifier, and the second amplifier; and
an opening formed in a position on the substrate below the first capacitance section, wherein a position on the substrate below the second capacitance section is closed.

3. The microphone according to claim 2, wherein a terminal for exchanging a signal with an outside is provided on another side of the substrate mounted with the cover.

4. The microphone according to claim 2, wherein a voltage supply terminal and a ground terminal are provided on another side of the substrate provided with the cover.

5. The microphone according to claim 2, wherein the opening is an inlet port for introducing pressure.

6. The microphone according to claim 2, wherein first rigidity of space defined by the substrate, the first capacitance section, and the cover is smaller than second rigidity of the first electrode of the first capacitance section.

7. The microphone according to claim 6, wherein the first rigidity is one-tenth or less of the second rigidity.

8. The microphone according to claim 1, further comprising a third amplifier having a capability of performing subtraction of an output signal from the first amplifier and an output signal from the second amplifier.

9. The microphone according to claim 8, wherein the first amplifier, the second amplifier, and the third amplifier are formed into a single IC.

10. The microphone according to claim 1, wherein the first amplifier and the second amplifier make up a capacitive coupling electric charge amplifier.

11. The microphone according to claim 1, wherein the output signal from the first amplifier and the output signal from the second amplifier are substantially opposite in phase to each other.

12. The microphone according to claim 1, wherein the first electrode of the first capacitance section and the second electrode of the second capacitance section are not connected to a ground potential.

13. The microphone according to claim 1, wherein the second electrode of the first capacitance section and the first electrode of the second capacitance section are not connected to the ground potential.

14. The microphone according claim 1, wherein the output signal from the first amplifier and the output signal from the second amplifier are connected to an analogue-digital converter that performs analogue-to-digital conversion, and an output signal is a digital signal.

15. The microphone according to claim 14, wherein the first amplifier, the second amplifier, and the analogue-to-digital converter are formed from an IC.

16. The microphone according to claim 14, wherein the analogue-to-digital converter is a Δ sigma modulator.

17. The microphone according to claim 14, wherein the digital signal is output in compliance with a pulse density modulation scheme.

18. The microphone according to claim 17, wherein a digital signal processor converts the digital signal output in compliance with the pulse density modulation scheme into an audio interface format and outputs a conversion result.

19. The microphone according to claim 1, wherein the first capacitance section and the second capacitance section are MEMS element sections.

20. The microphone according to claim 1, wherein a dielectric film is formed over a surface of the first electrode or the second electrode.

21. The microphone according to claim 20, wherein the dielectric film is an electret film.

22. A microphone comprising:
a first capacitance section and a second capacitance section that each have a first electrode which is a movable electrode and a second electrode which is disposed opposite the first electrode;
a substrate on which there are arranged the first capacitance section and the second capacitance section;
a cover arranged on the substrate so as to cover the first capacitance section and the second capacitance section; and
an opening formed in a position on the substrate below the first capacitance section, wherein
a position on the substrate below the second capacitance section is closed; and
a volume of space defined by the substrate, the first capacitance section, and the cover is ten times or more a volume of space closed by the second capacitance section and the substrate.
